(19) United States
(12) Patent Application Publication
(10) Pub. No.: US 2010/0177914 A1
(43) Pub. Date: Jul. 15, 2010

(54) ELECTROSTATIC THIN-FILM SOUND TRANSDUCER, AND METHOD FOR THE PRODUCTION THEREOF

(75) Inventors: Michael Heite, Olpe (DE); Martin Philipp Getrost, Sankt Augustin (DE); Rainer Kunz, Holzappel (DE); Thilo-J. Werners, Leverkusen (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/666,396

(22) PCT Filed: Jun. 27, 2008
(86) PCT No.: PCT/EP2008/058293

§ 371 Date: Dec. 23, 2009

(30) Foreign Application Priority Data
Jun. 28, 2007 (EP) 07111302.1

(51) Int. Cl. H04R 25/00; B05D 5/12

(52) U.S. Cl. 381/191; 427/58

(57) ABSTRACT

There is described an electrostatic film sound transducer, which comprises at least two laterally spaced-apart flat electrodes and at least one flat, electrically conductive layer (7) which is not electrically connected to these flat electrodes and is arranged over the two laterally spaced-apart electrodes. There is additionally described the production of the electrostatic film sound transducer and its use.

The present invention relates to an electrostatic film sound transducer, a method for its production and its use.

One of the important practical applications for a loudspeaker is the reproduction of speech or music in the case of an electroacoustic transmission. In this case, the loudspeaker constitutes, in the chain of transmission elements, the terminal element which, through its characteristics, determines in most cases the transmission quality that can be achieved.

There are various conventional loudspeaker systems, in which differing conversion principles are used for converting the supplied electrical power into an acoustic power. In the case of the majority of the known types of loudspeaker, a diaphragm, i.e. a sheet having a very small layer thickness, is used as a sound-emitting element.

A known type of loudspeaker is the electrostatic loudspeaker, which is used for special applications, for example as a high-frequency loudspeaker. In this case, two spaced-apart flat electrodes are electrically contacted and connected to an appropriately shaped audio amplifier, and an appropriate audio-frequency alternating voltage is applied. The electrodes used in this case can be realized as film.

The structure of the electrostatic loudspeaker thus corresponds to that of a capacitor. In this case, the loudspeaker diaphragm can be located between the two electrodes and controlled by the electric field; alternatively, it can also be one of the electrodes. According to the electrostatic principle, two electrodes having a like charge repel mutually, whereas two electrodes having an unlike charge attract mutually. If a voltage is applied to the electrodes of an electrostatic loudspeaker, the voltage level is a measure of the deflection of the electrodes. A high voltage causes a large deflection, and a low voltage causes a small deflection. A deflection in the opposite direction is caused by alteration of the polarity of the electrical voltage. The force acting upon the electrodes in this case is not linear, but proportional to the square of the voltage. A diaphragm is thereby made to vibrate, and sound is generated.

A film-based electrostatic loudspeaker constructed in this way can additionally enclose between the spaced-apart electrodes a piezoelectric layer, in the manner of a sandwich, for example. In the case of this embodiment, which is described in WO 2005/086528 A1, the piezoelectric material between the conductive layers causes the surface to vibrate when a variable voltage is applied. The disadvantage of such a loudspeaker structure is the relatively complex production of such a piezoelectric layer between two films, a loudspeaker constructed in this way being, in addition, relatively susceptible to mechanical stress.

A further electrostatic loudspeaker is known from EP 0 883 972 B1. This electrostatic loudspeaker has a plate-like structure. In this case, a porous stator plate is either electrically conducting or plated on at least one side to be electrically conducting. In addition, at least one movable diaphragm is provided with at least one electrically conducting surface. The electrostatic loudspeaker in this case has an arrangement in which the electrically conducting porous stator plates are arranged opposite each other and separated from each other by the diaphragm. Owing to the arrangement with an inner diaphragm, it is necessary for at least one stator plate to be porous, in order that the sound waves can leave the electrostatic loudspeaker.

The electrostatic loudspeaker described in EP 0 883 972 B1 is disadvantageous in that the porous stator plate can result in interference, and consequently in a limited acoustic power.

The film-based loudspeakers known from the prior art that are constructed in the manner of a capacitor additionally have a range of further disadvantages. Thus, it is necessary for both opposing film electrodes to be provided with an electrical connection, it being necessary, however, for at least the film electrode provided as a diaphragm to move. However, since the electrical connection of this film electrode realized as a diaphragm is generally stationary, the mobility of the film electrode is at least limited. As a result, harmonics are produced when the loudspeaker is operated. These harmonics produce unwanted distortions of the acoustic signals and thereby increase the harmonic content, which constitutes a measure of the quality of the sound produced.

Since, in general, one of the film electrodes is arranged to be movable and the other film electrode is arranged to be stationary, i.e. fixed, in such a electrostatic film loudspeaker, it is generally necessary for the two film electrodes to be provided with differing connection systems, which renders production of such film loudspeakers complex and cost-intensive.

In addition, both film electrodes are electrically contacted and receive a voltage of up to several thousand volts. In order to protect users of such film loudspeakers, the corresponding film-based electrodes are therefore provided with appropriate protective devices such as, for example, grilles, such that a user of such film loudspeakers can neither intentionally nor unintentionally touch the electrically live film electrodes. However, the shieldings used in this case result in the film loudspeaker having a relatively thick form overall.

In addition, there are frequently used for the purpose of shielding the voltage-carrying film electrodes grilles which, although they pass the produced sound, nevertheless at the same time cause, at least partially, sound reflection and, sometimes, interference, when the sound is diffracted at the respective grilles. This results overall in an unwanted reduction of the acoustic power and in a reduction of the quality of the sound signal.

Proceeding from this prior art, the present invention is based on the object of providing an electrostatic film sound transducer which preferably allows simple connection of the electrodes. In particular, the connection of the film electrodes is to be so realized that no harmonics are produced by the connection of the electrodes.

In addition, the electrostatic film sound transducer should preferably have a high degree of protection against contact, without at the same time the sound-emitting film structure being of a form that is excessively thick or disadvantageous for sound emission.

In addition, the electrostatic film sound transducer according to the invention is to be such that it can be produced efficiently in large quantities.

This object is achieved by an electrostatic film sound transducer which comprises at least two laterally spaced-apart flat electrodes and at least one electrically conductive layer that is not electrically connected to these flat electrodes and that is provided so as to be flat and substantially parallel to the two laterally spaced-apart electrodes, the at least two laterally spaced-apart flat electrodes being electrically contacted. In the context of the present invention, it is understood by the term “substantially parallel” that the angle formed between the plane formed by the at least two laterally spaced-apart electrodes and the plane formed by the electrically conductive layer is at most 45°, preferably at most 35°, especially preferably at most 25°, in particular at most 15°, specifically at most 10°, yet more specifically at most 5°.

Within the meaning of the invention, a film sound transducer comprises:
a preferably flat substrate, preferably a polymer film,
at least two laterally spaced-apart flat electrodes,
at least one intermediate layer,
an electrically conductive layer, which can be realized either as a floating electrode or as an earthed electrode, as a centre electrode.

The centre electrode, which can be realized either as a floating electrode, i.e. a non-contacted electrode which is galvanically isolated from the electrodes, or as an earthed electrode, is necessary for the function of the film sound transducer in the manner of causing the entire printed layer structure in itself to vibrate through, on the one hand, electrostatic interactions or, on the other hand, through piezoelectric effects. A combination of electrostatic interactions and piezoelectric effects is also possible. In electrotechnical terms, the centre electrode is located between the spaced-apart flat electrodes; in electrotechnical terms, therefore, the result is the series circuit of two capacitors with the centre electrode in the centre.

In this case, the electrostatic film sound transducer according to the invention has substantially the following structure:

### EMBODIMENT I

a preferably flat substrate, preferably a polymer film,
at least two laterally spaced-apart flat electrodes thereon,
at least one intermediate layer thereon,
the centre electrode thereon;
   or

### EMBODIMENT II

a preferably flat substrate, preferably a polymer film, as intermediate layer,
having at last two laterally spaced-apart flat electrodes on one side of the intermediate layer,
the centre electrode on the other side of the intermediate layer.

According to the invention, the flat electrodes, the intermediate layer, unless it is constituted by the substrate as in Embodiment II, and the centre electrode are preferably produced by printing technology, in particular intaglio printing and/or screen printing, and/or gravure technology and/or spray technology and/or dispenser technology and/or inkjet method.

Particularly preferably, according to the invention, the layers are produced by screen printing.

In Embodiment I, the substrate can be provided with a further layer before the electrodes are applied, in such a way that the original substrate can be removed following the completion of the layers.

Furthermore, for the purpose of producing Embodiment I, there can be applied to an original substrate, preferably by printing technology, firstly the centre electrode, then at least one intermediate layer, then at least two laterally spaced-apart flat electrodes and subsequently a layer serving as the actual substrate, the original substrate being removable following completion of the layers.

This structure of the electric film sound transducer according to the invention, which differs fundamentally from the film sound transducers of the prior art, makes it possible to resolve the above-mentioned disadvantages of the prior art. This is because, according to the invention, and in fundamental distinction from the prior art, it is no longer the case that two opposing flat electrodes, that are movable relative to one another, are arranged in the manner of a capacitor having a special intermediate layer structure, but at least two laterally adjacent flat electrodes are selected and a spaced-apart, electrically conductive sound-emitting electrode is used. In this case, the at least two electrically conductive electrodes are located together on one side of the electrically conductive sound-emitting film.

Owing to this structure it is possible, for example, for the at least two provided laterally arranged electrodes to be fitted with the same connection systems, as a result of which the film loudspeaker can be constructed more easily and less expensively.

In addition, the at least two provided laterally arranged electrodes are stationary. The connection of these at least two laterally arranged electrodes is therefore simpler than in the case of film electrodes in which the electrodes move. Moreover, there is a lesser problem in respect of the formation of harmonics (harmonic content).

Since the centre electrode, although being electrically conductive, need not be electrically live, the user of the film sound transducer according to the invention can touch the sound-emitting film without the risk of an electric shock. In particular, it is not necessary for the side of the film sound transducer comprising the centre electrode, according to the invention, to be protected, for example by a grille.

In addition, the film sound transducer according to the invention can be relatively thin in form, since a comprehensive insulation of the arrangement is not necessary.

Owing to the possibility of producing the entire film sound transducer by printing technology, in particular by screen-printing technology, this film sound transducer can be produced rapidly and inexpensively, in a standardized and reproducible manner, in large quantities.

### Special Design of the Film Sound Transducer According to the Invention

The size and shape of the respective electrodes and of the centre electrode can vary within wide ranges, and are generally not subject to any limitation. Accordingly, the electrodes and the centre electrode can be matched, with regard to their respective size, to the purpose of the film sound transducer according to the invention. The size ratio of electrodes to electrically conductive sound-emitting film can also vary.

It is thus possible, in a first embodiment, for the additive area of the at least two electrodes to be greater than the area of the electrically conductive sound-emitting film, i.e. for the at least two electrodes to project laterally beyond the centre electrode.

In a second embodiment, it is possible for the additive area of the at least two electrodes to be less than the area of the electrically conductive sound-emitting electrode, i.e. for the centre electrode to project laterally beyond the two electrodes.

In a third embodiment, it is possible for the additive area of the at least two electrodes to be substantially equal to the area of the electrically conductive sound-emitting film.

Of the aforementioned embodiments, there is preferred that embodiment in which the areas of the at least two electrodes and of the centre electrode are of substantially equal magnitude. If the area of the at least two electrodes is less than the area of the electrically conductive electrode, then only a lesser acoustic power can be produced, whereas, in the case of a greater area of the at least two electrodes in comparison with the area of the centre electrode, harmonics can be produced.

In the context of the film sound transducer according to the invention, there can be formed as individual elements such as, for example, the laterally spaced-apart electrodes or also, alternatively, the centre electrode, from coated films or from multiple layer sequences in the form of extrusions and coextrusions and lamination processes.

### Laterally Arranged Electrodes

According to the invention, at least two laterally spaced-apart electrodes are provided in the sound-emitting element. In the context of the present invention, the term “laterally spaced-apart electrodes” is understood to be an electrode arrangement in which the electrodes are provided adjacently in such a way that they are located on the same side of the centre electrode, i.e. that, in particular, no further layer is provided between the laterally spaced-apart electrodes.

The spacing between the laterally spaced-apart electrodes should be so selected, at least, that the dielectric strength is achieved and there is no breaking-down voltage.

In an embodiment of the film sound transducer according to the invention, the at least two laterally spaced-apart flat electrodes are connected to an audio amplifier. The audio amplifier is an audio source for a given alternating voltage that is suitable for transmitting, in the form of variable voltage, the audio frequencies to be produced to the respectively connected electrodes and for modulating the electric field accordingly in the film sound transducer.

In this case, a floating audio-frequency alternating voltage can generally be applied to the at least two laterally spaced-apart electrodes. It is also possible, however, for an earthed audio-frequency alternating voltage to be applied to the at least two laterally spaced-apart electrodes.

In a preferred embodiment of the present invention, there is applied, in addition to the audio-frequency alternating voltage, a bias voltage, whereby the sound level can be increased. In the context of the present invention, a bias voltage is understood to be a direct voltage in the sense of a bias voltage.

In this case, a bias direct voltage of >500 V, preferably >1000 V, can be applied between the conducting layers, an audio voltage having a maximum voltage amplitude of >200 V being able to be applied. Clearly, it is to be considered in this case that the maximum voltage amplitude of the audio voltage always remains less than the applied constant high voltage.

The at least two laterally spaced-apart flat electrodes are realized with electrical connections. In this case, consideration should preferably be given to an adequate electrical insulation and to the routing of the wiring of the connections or of the connection to the audio amplifier.

In a further preferred embodiment, the electrostatic film sound transducer can be realized to be integral with the electronic driving circuits of the audio amplifier and/or of the bias voltage. In this case, the corresponding electronic driving circuits of the audio amplifier and/or of the bias voltage can be provided on a substrate that also carries the electrostatic film sound transducer, i.e., for example, is integrally connected to the at least two laterally arranged electrodes. Possible substrates in this case are preferably printed wiring board and/or printed circuit boards that can also serve as a substrate for the electrostatic film sound transducer.

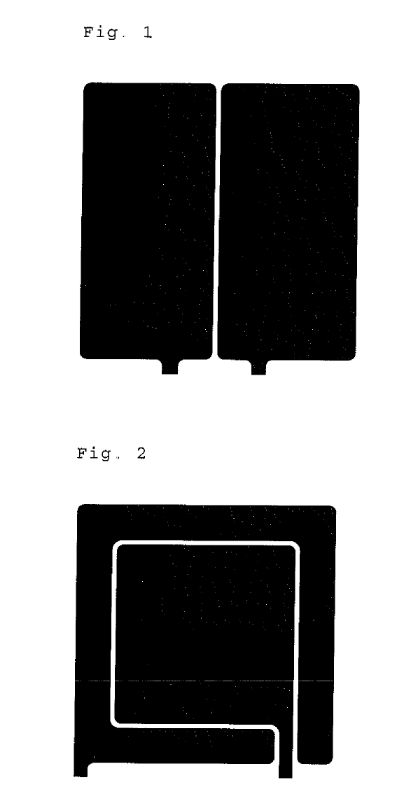

The electrodes themselves can be rectangular, rounded, spiral-shaped or comb-like in form, but with further forms or combinations of forms also being possible. Corresponding forms are represented in FIGS. 1 to 3:

FIG. 1: rectangular design

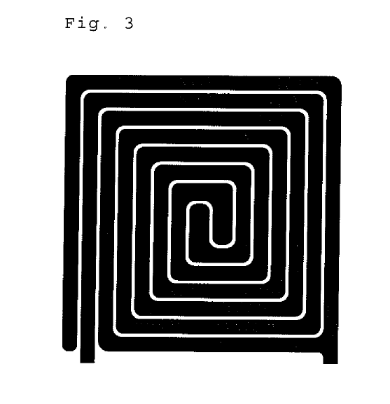

FIG. 2: rounded design

FIG. 3; spiral-shaped design

The geometric realization of the at least two laterally arranged electrodes should be effected such that the direct spacing of the electrodes is substantially greater than the spacing relative to the electrically conductive layer, and in practical realization is selected in the millimetre range to centimetre range, while the spacing of the electrodes relative to the electrically conductive layer can be in the range of some hundredths of mm to 10 mm.

In the case of the electrical contacting of the electrodes, consideration should be given to the fact that relatively high voltages are used with very small currents. However, the contact points should be closed or covered so as to effect good insulation, in order that no surface leakage currents can occur as a result of atmospheric humidity and dust or other contaminations.

In the context of the present invention, an electrostatic film sound transducer can also have multiple electrode pairs and the latter can be supplied via only one audio source or audio-frequency alternating voltage or, alternatively, via a plurality of audio-frequency alternating voltages or with audio-frequency alternating voltages of differing phase position.

The laterally arranged flat electrodes, including the connections, can be covered with an insulation layer, preferably an insulation layer that is tight to air bubbles. This insulation layer is a layer which preferably has a dielectric strength greater than air. This insulation layer can be applied in liquid form by means of printing technology or gravure technology or spray technology or dispenser technology or in the form of a thin film. A lacquer known from printed circuit board production, for example, can be used as an insulation layer.

In principle, a film having electrodes on the back side can also be used.

The laterally arranged electrodes should preferably be very well covered, without air inclusions, by the insulation layer, since the audio-frequency alternating voltage or a bias voltage requires a good dielectric, constant, insulating covering of the electrodes.

### Centre Electrode

The centre electrode, which can be realized either as a floating electrode or as an earthed electrode and which is arranged over the two laterally spaced-apart electrode, is realized in the form of a layer, this layer being realized to be electrically conductive.

The central electrode can be earthed or non-earthed. For safety reasons it is preferred that the centre electrode be realized as an earthed electrode.

The conductivity per unit area of the centre electrode is dependent on the sound-emitting element, and can be greater than 2,000 ohms/square in the case of small-area elements and less than 500 ohms/square in the case of large-area elements. The surface conductivity is preferably less than 2,000 ohms/square, in particular less than 1,000 ohms/square.

The electrical conductivity of the centre electrode can be obtained in various ways. Thus, for example, an electrically conductive layer can be provided on an appropriate film material, for example by vacuum coating. In addition, however, it is also possible to produce the centre electrode through rolling technology or through electroplating technology. Alternatively, it is additionally possible to produce the centre electrode by printing technology with use of an electrically conductive printing paste. The printing paste in this case can be based on a paste that is mixed with metals and/or other electrically conductive fillers. Preferred in this case are silver pastes, copper pastes, CNT-containing pastes (CNT=Carbon Nano-Tubes), intrinsically electrically conductive polymers, pastes which contain intrinsically conductive polymers, or are based on the combination of two or more of the said printing pastes. Further application methods for the electrically conductive layer are, for example, so-termed sputtering methods, screen printing methods, inkjet methods or intaglio printing methods.

Also possible is the use of a film material made from an electrically conductive material (for example, from an electrically conductive polymer). Such conductive polymers are described further below.

Preferred conductive polymers are conductive polythiophene, in particular conductive polyalkylene-dioxythiophene. The production is described, for example, in DE 41 18 704 and EP 0 339 340. A preferred conductive polymer is 3,4-polyethylene-dioxythiophene. An appropriate commercial product is Clevios® P by H. C. Starck, an aqueous dispersion having 0.5 wt. % 3,4-polyethylene-dioxythiophene (PEDOT) and 0.8 wt. % polystyrene sulfonate (PSS). Further preferred intrinsically conductive polymers are conductive polyaniline, e.g. Versicon® (Allied Signal), a polyaniline having a conductivity of 2-4 S/cm or Ormecon® (Zipperling Kessler & Co.).

Printing pastes that contain silver, other metals, carbon, nano-particles, conductive polymers and/or other electrically conducting materials are commercially available, and known to persons skilled in the art. Thus, for example, pastes by Agfa Gevaert GmbH, in particular the EL-P3000 series, the EL-P4000 series, the EL-P5000 series and the EL-P6000 series, and the L5000, L5001, L5002, L5003, L5004, L5005, L5006, L5007 or 6510-108-005 pastes by Ormecon, or also paste filled with silver, other metals, carbon or other electrically conductive materials such as, for example, Luxprint 8144, 7152, 7162, 9145, 7102, 7105, 5000 or 7164 by DuPont de Nemours and Company, the Electrodag said pastes by Acheson Industries Ltd. such as, for example, Electrodag PF-410, 725A, 418 SS, PF-407C or 965 SS, or pastes having the designation L5000, L5001, L5002, L5003, L5004, L5005, L5006, L5007, L5008W or 6510-108-005 by Ormecon GmbH, and conductive coating systems or printing ink systems by Panipol OY can be used.

Besides ready-formulated commercially available pastes for the production of electrically conductive coatings, pastes according to the invention can also be self-formulated. Used in preference according to the invention, for the purpose of formulating a printing paste for the production of an electrically conductive coating, is 10 to 90 wt. %, preferably 20 to 70 wt. %, particularly preferably 30 to 60 wt. %, relative to the total weight of the paste in each case, of Clevios P, Clevios PH, Clevios P AG, Clevios P HCV4, Clevios P HS, Clevios PH, Clevios PH 500, Clevios PH 510 or any mixtures thereof. Dimethyl sulfoxide (DMSO), N,N-dimethyl formamide, N,N-dimethylacetamide, ethylene glycol, glycerine, sorbitol, methanol, ethanol, isopropanol, n-propanol, acetone, methyl ethyl ketone, dimethylaminoethanol, water, or mixtures of two or three or more of the said solvents can be used as solvent. The quantity of solvent in paste can vary within wide ranges. Thus, 55 to 80 wt. % solvent can be contained in a formulation of a screen-printing paste according to the invention, while approximately 35 to 80 wt. % of a solvent mixture of two or more solvents can be used in another formulation according to the invention. Furthermore, Silquest A187, Neo Rez R986, Dynol 604 and/or mixtures of two or more of these substances can be included as interfacial additive and adhesion activator. The quantity of these substances is preferably 0.3 to 2.5 wt. % relative to the total weight of the screen-printing paste.

Furthermore, a binding agent, preferably as an aqueous emulsion, can be added to the paste. Thus for example, Bayderm UD-85 by Lanxess, or an aqueous suspension of a polyuretha by Bayer Material Science can be used, for example Bayhydrol 850 W, Bayhydrol A 145, Bayhydrol A 242, Bayhydrol B 130, Bayhydrol D155, Bayhydrol D 270, Bayhydrol D 356, Bayhydrol F 245, Bayhydrol FT 145, Bayhydrol PR 135, Bayhydrol P240, Bayhydrol P340/1, Bayhydrol PR 241, Bayhydrol PT 355, Bayhydrol PT 475 and Bayhydrol UV 2282 or the NeoRez® aqueous urethane dispersions by DSM NeoResins B.V. or mixtures of two or more of the said binding agents. These binding agents are preferably used in quantities of approximately 0.5 to 30 wt. %, preferably 3 to 20 wt. %.

A particularly preferred formulation of a printing paste, according to the invention, for the production of the partially transparent electrode contains:

| | | | Content/ |
|---|---|---|---|
| Substance | Content/wt. % | Content/wt. % | wt. % |
| Clevios P HS (HC Starck) | 30.3 | 41.2 | 49.8 |
| Silquest A187 (OSi | 1.0 | 1.0 | 1.0 |
| Specialties) | | | |
| N-methyl-pyrrolidone | 15.2 | 10.0 | 10.2 |
| Diethylene glycol | 29.5 | 25.7 | 22.0 |
| Proglyde/DMM | 19.0 | 17.4 | 12.0 |
| UD-85 (Lanxess) | 5.0 | 4.7 | 5.0 |

After these electrode materials have been applied to a corresponding substrate, they are subsequently dried at temperatures of, for example, 80 to 120° C.

Moreover, indium tin oxide materials (ITO) can also be applied to the corresponding substrate, such that a corresponding electrode is realized. Furthermore, layers of ATO-based electrically conducting materials can be applied. ATO in this case is antimony tin oxide.

If a CNT-containing printing paste is used, this paste contains particles having nano-structures. In the context of the present invention, the term “particles having nano-structures” is understood to be nano-scale material structures that are selected from the group consisting of single-wall carbon nanotubes (SWCNTs), multi-wall carbon nanotubes (MWCNTs), nanohorns, nanodisks, nanocones (i.e. structures having a conically shaped envelope), metallic nanowires and combinations of the aforementioned particles. Corresponding particles having carbon-based nano-structures can consist, for example, of carbon nanotubes, (single-walled and multi-walled), carbon nanofibres (herringbone, platelet, screw-type) and the like. Internationally, carbon nanotubes are referred to by the English-language term carbon nanotubes (single-walled and multi-walled), and carbon nanofibres by the English-language term carbon nanofibres (herringbone, platelet, screw-type).

With regard to metallic nanowires, reference is made to WO 2007/022226 A2, whose disclosure with regard to the nanowires disclosed therein is included in the present invention by reference. The silver nanowires described in WO 2007/022226 A2, which have good electrical conductivity and are largely transparent, are particularly suitable for the present invention.

Through the use of particles having nano-structures, the electrical conductivity can be appropriately designed in such a manner, or the flexibility and non-susceptibility to hairline crack formation in the conducting layers can be improved in such a manner, i.e. an appropriate elasticity (characterized by the material characteristic value, modulus of elasticity).

If the centre electrode is formed from a metal, then, in a preferred embodiment of the present invention, aluminium is used for the electrically conductive layer. Aluminium is a light metal which does not interfere with the vibrations of the film sound transducer and which at the same time can easily be vapour-deposited onto a film material.

If a film material is used onto which, for example, a metal such as aluminium is applied, this film material can be composed, for example, of a thermoplastic material. A corresponding polymer film can also be used, in particular, when a graphical design of the film sound transducer is provided. In this case, the graphical design can be provided on the polymer film. In this case, the graphical design of the polymer film may be effected on one side of the film or, alternatively, also on both sides of the film. A graphical design can be effected, for example, by screen-printing or inkjet. Stamping of the film is also possible.

In a preferred embodiment of the present invention, the thermoplastic material of the film is selected from the group consisting of polycarbonate (PC), oriented polypropylene (OPP), polypropylene (PP), polyethylene terephthalate (PET), acrylonitrile butadiene styrene rubber (ABS), polyvinyl fluoride (PVF), polymethyl methylacrylate (PMMA), polyethylene (PE), biaxially oriented polypropylene (BOP) and polyimide (PI). Particularly preferred are films made of polypropylene and polycarbonate, possibly in combination with a metal coating, for example an aluminium coating. The electrically conductive layer can additionally be bonded onto a corresponding film material.

The requirements for the adhesives consist in the good, enduring bond of the adhesive partners with a material application that is as thin as possible. In principle, in this case, solvent-containing adhesive systems, 2-component adhesive systems and also reactive or partially reactive adhesive systems or hot-melt adhesive systems can be used.

In a further embodiment of the centre electrode, the latter can be produced by vacuum technology, by means of sputtering technology or vapour-deposition technology, particularly aluminium-based, or a thin aluminium layer or aluminium film that has been rolled or formed by electroplating can be used.

A carrier material, preferably a polymer film, can be used for the centre electrode, including without coating if the carrier material itself is already designed to be electrically conductive.

Intrinsically conductive polymers are usually ethylenically unsaturated and conjugated, rendering possible ease of charge transport in the polymer molecule. Such polymers are also termed organic metals. They have a conductivity of at least 10⁻⁵, preferably of at least 10⁻², particularly preferably of at least 1 Siemens/cm, Appropriate intrinsically conductive polymers are selected, for example, from polymers based on polyaniline, polyanisidine, polydiphenylamine, polyacetylene, polythiophene, polythioprene, polythienylenevinylene, bithiophene, polypyrrol and polycroconaine and their derivatives. Such polymers are frequently rendered electrically conductive by means of doping. This can be effected chemically or electrochemically. Through treatment with oxidation means such as iodine, sodium peroxide disulfate or bromine or a strong acid, appropriate polymers become partially oxidized and thereby electrically conductive. Other polymers can be rendered electrically conductive through partial reduction with reduction means. These methods are generally known. The production of intrinsically conductive polyaniline and polypyrrol is described, for example, in EP 0 539 123. Appropriate polymers are, for example, polyradical cations.

For an increased stability of the formulations, it is recommended that the polyradical cations be used in combination with polymeric anionic compounds (polyanions), and that the compositions do not contain further cationic substances whose counter-ions compete for the polyanions and result in precipitations.

The carrier material, preferably a polymer film, onto which the centre electrode is applied, or which serves as a centre electrode, preferably has a thickness of 5 to 500 μm, particularly preferably 10 to 200 μm, in particular 15 to 100 μm.

In a further embodiment, it is possible for the centre electrode as a whole to consist of three or more layers, at least one layer being realized to be electrically conductive.

The centre electrode can be earthed or non-earthed.

### Layer Between the at Least Two Laterally Spaced-Apart Electrodes and the Centre Electrode: Intermediate Layer

The electrostatic film sound transducer according to the invention preferably has at least one further layer between the at least two laterally spaced-apart flat electrodes and the centre electrode. This layer is realized to be electrically non-conducting (dielectric layer). This layer can also be air.

What is decisive is that this layer be so realized that no electrical contact occurs between the laterally arranged electrodes and the centre electrode.

In a first design of the layer, the electrostatic film sound transducer according to the invention has a layer which is realized to be permeable to air.

In a second design of the layer, the electrostatic film sound transducer according to the invention has a layer which is elastically compressible.

In a third design of the layer, the electrostatic film sound transducer according to the invention has a layer which has non-polar and polar characteristics, i.e. a layer which has electret characteristics. In the context of the present invention, an electret is understood to be an electrically insulating material which contains quasi-permanently stored electric charges and/or quasi-permanently oriented electric dipoles and consequently produces a quasi-permanent field around or within itself.

In a fourth design, the features mentioned previously in the first to third designs are optionally combined.

Irrespective of the characteristics of the layer that are described above and preferably present, this layer is preferably realized as a foam layer, a nonwoven material or an elastic screen-printing formation, a screen-printing layer, the above-mentioned and preferred characteristics of the layer being achieved through selection of appropriate materials. For example, this electrically non-conducting layer can thus be realized as an elastic foam. In principle, both closed-pore and open-pore foam can be used in this case, although open-pore foam is more favourable with regard to the pressure equalization necessary for sound improvement.

Furthermore, the non-conducting intermediate layer can also be realized as an elastic textile fabric made from individual fibres without filler, a so-termed nonwoven material. It is pointed out in this case that this nonwoven material is preferably not paper, since the paper has large proportions of non-elastic filler and is therefore not suitable.

The layer in the electrostatic film sound transducer according to the invention can have a thickness of 20 μm to 10 mm, particularly preferably 30 μm to 200 μm.

Commercially available pastes by means of which an electrically insulating coating can be produced, for example by the screen-printing method, as well as self-formulated pastes, can be used for producing an insulating layer for the third design of the layer (layer having electret characteristics). These pastes contain a binding agent and one or more organic or inorganic fillers. In addition, these pastes can have one or more solvents and one or more optional additives. Particularly suitable within the meaning of the invention in this case are pastes whose constituents are, inter alia, materials having a high dielectric constant. A high dielectric constant can be achieved, for example, through an inorganic filler and/or through the selection of an appropriate binding agent. Possible inorganic fillers are those which themselves have a high dielectric constant. BaTiO₃, SrTiO₃, KNbO₃, PbTiO₃, LaTaO₃, LiNbO₃, GeTe, Mg₂TiO₄, Bi₂(TiO₃)₃, NiTiO₃, CaTiO₃, ZnTiO₃, Zn₂TiO₄, BaSnO₃, Bi(SnO₃)₃, CaSnO₃, PbSnO₃, MgSnO₃, SrSnO₃, ZnSnO₃, BaZrO₃, CaZrO₃, PbZrO₃, MgZrO₃, SrZrO₃, ZnZrO₃ and TiO₂ or mixtures of two or more of these fillers can be used. Preferred according to the invention are BaTiO₃ or PbZrO₃ or mixtures thereof, preferably in fill quantities of 5 to 80 wt. %, preferably from 10 to 75 wt. %, particularly preferably from 40 to 70 wt. %. Binding agents having a high dielectric constant are, for example, Cyanoresin by Shin Etsu, or also PVDF, which is offered by DuPont, for example, as a ready-formulated binding agent. For example, the 8153, 3571, 5017A, 5018, 5036 pastes by DuPont can be used to produce an insulation layer according to the invention. Further commercially available systems are Electrodag 452 SS and Electrodag PF-455 by Acheson.

For the purpose of formulating a printing paste for the purpose of producing an insulation layer according to the invention, one-component polyurethane systems or, preferably, two-component polyurethane systems can be used, for example, as binding agent, for example those by Rhodia, Degussa (Vestanat, e.g. Vestanat T and B), Sapici, Benasedo, Synthesia, Baxenden, Dow (brand names, e.g. Vorastar), Acheson, ICI, Hausman and CIBA. As raw materials for the binding agent system, it is possible to use polyether polyols or polyester polyols, as well as aromatic and aliphatic diisocyanates of Bayer Material Science AG, preferably Desmodur and Desmophen. Ethyl acetate, butyl acetate, 1-methoxypropyl acetate-2, ethoxypropyl acetate, toluene, xylene, Solvesso 100, Shellsol A or mixtures of two or more of these solvents, for example, can be used as a solvent. Furthermore, additives such as levelling agents and rheology additives can also be added to improve the characteristics. Rheology additives reduce the settling behaviour of fillers in the paste. Such rheology additives, for example by BYK or Elementis, are known to persons skilled in the art. Levelling agents that can be used are, for example, additives by Cytec Industries Inc., such as Modaflow Resin or Additol VXL 4930 or an additive mixed with solvents, preferably 40 to 60% Additol XL 480 or Additol XL 490 in butoxyl.

The dielectric layer preferably has a dielectric constant of more than 5, preferably more than 20, particularly preferably more than 50, very particularly preferably more than 70.

Preferred pastes for a printing paste for the production of insulation layers according to the invention contain, for example:

| Substance | Content/wt. % | Content/wt. % | Content/wt. % |
|---|---|---|---|
| BaTiO₃ | 51.7 | 60.8 | 69.0 |
| Desmophen 1800 | 26.2 | 20.4 | 14.0 |
| (BMS) | | | |
| Desmodur L67 | 15.8 | 10.3 | 7.0 |
| MPA/X (BMS) | | | |
| Ethoxypropyl | 6.0 | 0 | 0 |
| acetate | | | |
| 1-Methoxy-2- | 0 | 8.3 | 9.6 |
| propylacetate | | | |
| Additol XL480 | 0.3 | 0.2 | 0.4 |
| (50% in butoxyl) | | | |

A layer, according to the invention, that is produced by the screen-printing method and using the pastes described above has a layer thickness of 5 to 50 μm, preferably 8 to 40 μm.

### Substrate

In a preferred embodiment, the electrostatic film sound transducer (1) according to the invention is arranged on a substrate. The substrate in this case can be formed in a variety of ways.

The substrate is preferably so realized that it has an appropriate mass or inertia in respect of the sound produced by the electrostatic film sound transducer. In a first embodiment, the substrate can have the form of a wallpaper-type element which is fastened by adhesion to a possible wall element, floor element or ceiling element.

For example, according to a simple practical realization, such an electrostatic film loudspeaker can be fastened, e.g. “wallpapered-on” to a wall element. In this case, a directed sound emission over a plurality of metres, up to 100 m and above, is already achieved in this basic realization with an extremely thin layer structure of approximately 1 to 5 mm, in particular less than 4 mm, and dimensions in the range of 0.5×0.5 m.

Should the substrate in such an embodiment be fastened to a wall element, floor element or ceiling element, it is not absolutely necessary for the substrate itself to have a particular inherent stiffness. If the substrate does not have an appropriate inherent stiffness, the mass of the wall element, floor element or ceiling element to which the substrate is fastened should then nevertheless be of such magnitude that the substrate, in combination with the wall element, floor element or ceiling element, has a sufficient inertia in respect of the sound. Optimum sound radiation is thereby rendered possible.

Alternatively, in a further design, the substrate itself can also be realized as an intrinsically stiff or mass-inert element. In such a case, it is possible to apply to the electrostatic film sound transducer to any position, for example in a room or, also, in the open. In such a case, the intrinsically stiff substrate, with the correspondingly associated electrostatic film sound transducer, can be detachably or non-detachably fastened to other wall elements, floor elements or ceiling elements by means of fastening devices such as, for example, adhesive, screwed, clamping or plug-in fastenings. Tithe substrate provided according to the invention is itself realized to be intrinsically stiff in such a case, it is not necessary for the elements to which the substrate is fastened to have a certain inertia in respect of the sound.

In an embodiment, it is preferred if the substrate has a weight per unit area that corresponds to at least 10 times, preferably at least 100 times the weight per unit area of all other layers of the film sound transducer.

In a further embodiment of the present invention, the substrate is realized three-dimensionally in such a way that the sound is radiated in a targeted manner. In such a case, the arrangement with targeted orientation of the film sound transducer according to the invention is also advantageous.

In a further embodiment of the present invention, the substrate provided according to the invention can be realized in that it is clamped in a frame. Depending on the thickness of the substrate, both a one-sided and a two-sided sound radiation are possible in this case, it being also possible, particularly in the case of Embodiment I described above, in the case of a two-sided sound radiation, for two film sound transducers according to the invention to be arranged back-to-back, and for this arrangement then to have a respective substrate, i.e. at least two substrates, or a common substrate. The term back in this case is understood in this case to be the surface that substantially does not emit sound, the substrate side of the film sound transducer.

Besides being fastened by thermally activated fastening, the electrostatic film sound transducer according to the invention can be fastened at the frame equally well by cold adhesion systems or liquid adhesives or a mechanical fastening or ultrasound or friction welding.

In a further embodiment of the present invention, provision is made whereby the substrate is a frame into which the acoustically active loudspeaker surface (electrically conductive sound-emitting film) is clamped. This variant makes it possible, for example, to emit sound to large-area buildings or open spaces. Here, the substrate constituting a frame is realized in the manner of a protective electrode.

Alternatively, or in addition to such a protective electrode, there is also the possibility of providing an electronic circuit which short-circuits or switches off the high-voltage supply in a hazard situation. A hazard situation that can be detected is, for example, an abnormally high current flow at the high-voltage supply or a sudden voltage drop, which indicates a short-circuit between audio potential and bias potential.

In addition, it is possible to apply a further, outer, non-conducting insulation layer, which additionally has a protective effect against the high-voltage potential prevailing in the film loudspeaker. Such an insulation layer can be applied, for example, in the form of an insulation lacquer, or a non-conducting plastic film can be used as an additional insulation layer, which plastic film is applied as an outermost layer of the film loudspeaker. According to the invention, however, this insulation layer can also be produced by printing technology, in particular intaglio printing and/or screen printing, and/or gravure technology and/or spray technology and/or dispenser technology and/or inkjet method. Preferably, this layer is produced by screen printing.

It is possible for the electrostatic film sound transducer according to the invention to be deformed three-dimensionally. The precise three-dimensional deformation of graphically designed plastic films having very short clock cycles of a few seconds can be effected, according to the prior art, with use of the isostatic high-pressure deforming method (HDVF), which is described in detail in EP 0 371 425 B1 (Method for producing deep-drawn plastic formed parts) and which necessitates the use of cold-drawable films, for example films having the designation Bayfol® CR(PC/PBT film) or Makrofol® DE by the company Bayer AG. Besides the thermoplastic film that is deformable below Tg (Tg=glass transition temperature), appropriately deformable screen-printing inks, for example inks by the company Pröll KG in D-91781 Weiβenburg in Bavaria having the designation Aquapress® or Noriphan® are preferred for the achievement of visually attractive products. The electrostatic film sound transducer according to the invention can thus be three-dimensionally deformable, the radii of curvature being able to be less than 2 mm, preferably less than 1 mm. The deformation angle in this ease can be greater than 60°, preferably greater than 75°, particularly preferably greater than 90°, in particular greater than 105°.

### System:

A further subject-matter of the present invention is a system comprising at least two electrostatic film sound transducers as described above.

In this case, the at least two electrostatic film sound transducers can be so arranged that the sound radiation is effected substantially parallelwise. In addition, it is also possible for the sound radiation to be effected substantially in a non-parallel manner. In particular, it is possible for the film sound transducers to be arranged substantially in exactly opposing directions, such that the sound radiation is effected in exactly opposing directions.

In this case, the at least two electrostatic film sound transducers used in the system are supplied with an audio-frequency alternating voltage and/or bias voltage or with two or more audio-frequency alternating voltages and/or bias voltages that are differently tuned to each other.

### Method for Production

The film sound transducers according to the invention can be produced using the methods and method steps known per se to persons skilled in the art.

In general, a substrate is used, on which the two laterally spaced-apart electrodes are applied. The fastening of the electrodes can be effected in a variety of ways. For example, it is possible for these electrodes to be fixedly bonded to a substrate or to be fixed in another manner.

The centre electrode, which is spaced apart from said electrodes, is fixed in place at a distance from these two electrodes. Fixing can be effected by, for example, a frame, into which the centre electrode is clamped. The connections of the electrodes are effected in a manner known per se to persons skilled in the art.

Preferably according to the invention, however, the flat electrodes, the intermediate layer, unless it is constituted by the substrate as in Embodiment II, and the centre electrode, which can be realized either as a floating electrode or as an earthed electrode, are preferably produced by printing technology, in particular intaglio printing and/or screen printing, and/or gravure technology and/or spray technology and/or dispenser technology and/or inkjet method. Particularly preferably, according to the invention, the layers are produced by screen printing.

Further subject-matter of the present invention is the use of an electrostatic film sound transducer as described above, or of a corresponding system comprising a plurality of these electrostatic film sound transducers, as an active sound-emitting element in a building, in land vehicles, water craft or aircraft, for the purpose of targeted sound emission and for the purpose of sound reduction in the sense of sound emission in opposition of phase.

The invention is described more fully in the following with reference to the preferred exemplary embodiments and the figures, only the features necessary for understanding of the invention being represented:

In particular:

FIG. 1: shows a rectangular design of the laterally arranged electrodes

FIG. 2: shows a rounded design of the arranged electrodes

FIG. 3: shows a spiral-shaped design of the arranged electrodes

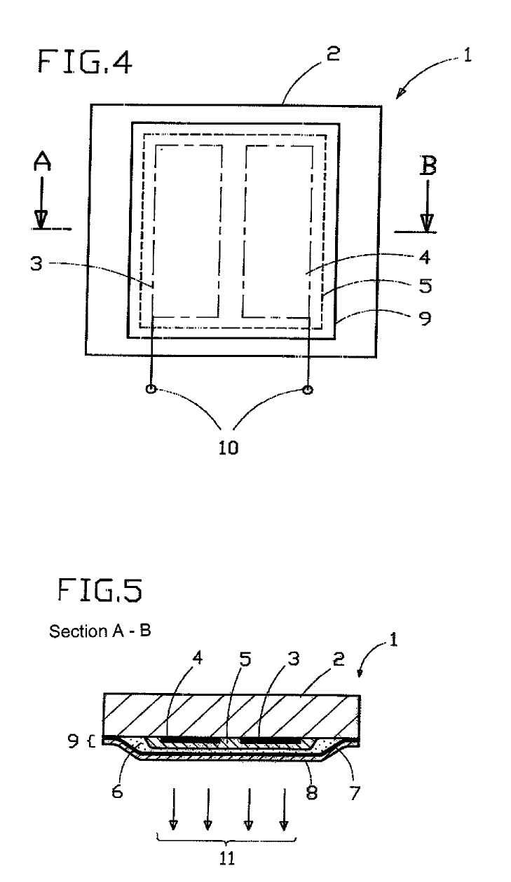

FIG. 4: shows in plan view a schematic representation of an exemplary electrostatic film sound transducer element (1) having two symmetrically arranged lateral electrodes (3, 4) of approximately equal area, and

FIG. 5: shows a schematic section A-B of an exemplary electrostatic film sound transducer (1) having two symmetrically arranged lateral electrodes (3, 4) of approximately equal area.

Shown in FIG. 4 in plan view is a schematic representation of an exemplary electrostatic film sound transducer element (1) having two symmetrically arranged lateral electrodes (3, 4) of approximately equal area.

The substrate (2) in this case can be formed in a multiplicity of ways. In the embodiment in the form of a wallpaper-type element, the substrate (2) requires almost no intrinsic stiffness and can be fastened by adhesion to a wall element, floor element or ceiling element that is as flat as possible, it being necessary for the mass of this wall element, floor element or ceiling element to be of corresponding magnitude and thereby having a certain inertia in respect of sound and rendering possible an optimum sound radiation.

Alternatively, the substrate (2) itself can be realized as an intrinsically stiff or mass-inert element and can thereby be arranged freely in a space, or it can be detachably or non-detachably fastened to a wall element, floor element or ceiling element by means of adhesive, screwed, clamping or plug-in fastening or suchlike fastening technologies according to the prior art.

In a further inventive embodiment, the substrate (2) can be realized with three-dimensional shaping and can thereby radiate the sound in a targeted manner.

In a further embodiment, the substrate (2) can be realized in that it is clamped into a frame, whereby, depending on the realized thickness of the substrate (2), a one-sided sound radiation can be achieved or, in the case of two-sided realization, a two-sided sound radiation can also be achieved.

At least two flat laterally arranged electrodes (3, 4) are realized on the substrate (2). The production of these electrodes (3, 4) can be effected according to methods applied in the domain of flexible or rigid printed circuit board technology, or conductive printing pastes can be used for production by printing technology, or thin conductive film elements can be applied laterally next to each other.

The geometric realization of the at least two laterally arranged electrodes (3, 4) should preferably be effected at least such that the direct spacing of the electrodes (3, 4) is substantially greater than the insulation spacing relative to the centre electrode (7, FIG. 5), and in practical realization is selected in the millimetre range, while the insulation spacing is in the range of some 10 to 100 μm. A symmetrical, equal-area realization is illustrated in FIG. 4. Equally possible, however, are embodiments of unequal area and non-symmetrical embodiments, and the electrodes can be realized as rectangular or rounded or spiral-shaped or comb-type forms; cf. FIGS. 1 to 3.

The at least two laterally arranged flat electrodes (3, 4) are realized with electrical connections (10).

The electrodes (3, 4), including the connections (10), are covered by an insulation layer (5). This layer (5) can be applied in liquid form by means of printing technology or gravure technology or spray technology or dispenser technology, or in the form of a thin film. In principle, a film (5) having electrodes (3, 4) on the back side can also be used.

In the simplest embodiment, a floating centre electrode (7) can now be arranged over an intermediate layer (6) (foam layer (6) or nonwoven material element (6) or elastic screen-printing formation (6)) on the substrate (2) having the electrodes (3, 4) and the insulation layer (5).

Illustrated in FIG. 5 is a schematic section A-B of an exemplary electrostatic film sound transducer element (1) having two symmetrically arranged lateral electrodes (3, 4) of approximately equal area.

In this case, the sound radiation (11) is effected in one direction. In principle, however, in the case of appropriate substrate realization (2) and appropriate electrode design (3, 4) and appropriate layer selection (5, 6, 7, 8, 9), the sound radiation (11) can also be effected in the 180-degree opposing direction, the substrate in this case preferably being realized in that it is clamped into a frame.

In this exemplary embodiment, the film element (9), consisting of the layers 7 and 8 (FIG. 5) is connected, at the edges, to the substrate surface (2). In this case, the film element (9) can be provided with an acrylate coating on the inside, and this coating can be realized by a thermally acting stamping die that is very easy to use. Besides thermally activated fastening, however, cold adhesion systems or liquid adhesives or a mechanical fastening or ultrasound or friction welding can be used equally well. The various layers or films (2, 3, 4, 5 6, 7, 8) can also be inserted into an injection moulding tool and at least provided with a frame. In addition, a thermoplastic injection-moulded grille can be realized in a very great variety of design embodiments best known from loudspeaker covering grille systems in automobile construction. Dual screw injection machines, having differing thermoplastic materials and characteristics, can also be used in this case, and insertion injection moulding technologies can be used. In this case, the electrical connections can be concomitantly integrated in a very simple manner.

The schematic section A-B in FIG. 5 is merely an exemplary embodiment. In principle, the laterally arranged electrodes (3, 4) can also be taken as far as the edge of the substrate (2) and, in principle, the flat elements (2, 3, 4, 5, 6, 7, 8, 9) can be formed as layers or from films or from coated films or from multiple layer sequences in the form of extrusions and coextrusions and lamination processes.

It may also be appropriate, for visual, design and functional reasons, for the film sound transducer to be graphically designed. However, an additional film (not illustrated) can also be applied over the film sound transducer. This additional film can be graphically designed on the inside and/or on the outside, and this film, like the film element (9), can be provided with a conductive layer, and this conductive layer can be connected to earth and can be used in this manner as an additional protection against contact in the case of the foil element (9) being damaged.

### LIST OF REFERENCES

1 Electrostatic film sound transducer
2 Substrate
3, 4 Laterally arranged electrodes
5 Insulation layer
6 Intermediate layer
7 Centre electrode
8 Carrier material for the centre electrode
9 Film element consisting of layers 7 and 8
10 Electrical connections
11 Sound radiation

1.-18. (canceled)

19. An electrostatic film sound transducer comprising:
at least two laterally spaced-apart flat electrodes (3, 4), each being configured to be electrically contacted (10); and
at least one flat centre electrode (7), which is not electrically connected to the flat electrodes (3, 4) and is arranged over the two laterally spaced-apart electrodes (3, 4).

20. The electrostatic film sound transducer (1) according to claim 19, further comprising:
a flat substrate (2), preferably a polymer film, and
at least one intermediate layer (6).

21. The electrostatic film sound transducer (1) according to claim 19, further comprising:
a flat substrate (2), wherein the at least two laterally spaced-apart flat electrodes (3, 4) are disposed thereon,
at least one intermediate layer (6) disposed on the at least two laterally spaced-apart flat electrodes (3, 4), and
a centre electrode (7) disposed on the at least one intermediate layer (6).

22. The electrostatic film sound transducer (1) according to claim 19, further comprising a preferably flat substrate (2), wherein the at last two laterally spaced-apart flat electrodes (3, 4) are disposed on one side of the flat substrate (2), and the centre electrode (7) are disposed on the other side of the flat substrate (2).

23. The electrostatic film sound transducer (1) according to claim 19, wherein an audio-frequency alternating voltage is applied to the at least two laterally spaced-apart electrodes (3, 4).

24. The electrostatic film sound transducer (1) according to claim 23, wherein a bias voltage is applied in addition to the audio-frequency alternating voltage.

25. The electrostatic film sound transducer (1) according to claim 19, further comprising an intermediate layer (6) disposed between the at least two laterally spaced-apart flat electrodes (3, 4) and the centre electrode (7).

26. The electrostatic film sound transducer (1) according to claim 25, wherein the intermediate layer (6) has a thickness of from 20 μm to 10 mm.

27. The electrostatic film sound transducer (1) according to claim 19, further comprising a substrate (2) onto which the laterally spaced-apart electrodes (3, 4) are arranged.

28. A method for producing an electrostatic film sound transducer (1) comprising:
arranging two laterally spaced-apart electrodes (3, 4) on a substrate, and
arranging a centre electrode (7) on and spaced-apart from the two laterally spaced-apart electrodes (3, 4).

29. The method for producing an electrostatic film sound transducer (1) according to claims 28, wherein the at least two laterally spaced-apart flat electrodes (3, 4) and the one centre electrode (7) are produced by a printing technology selected from one or more of intaglio printing, screen printing, gravure technology, spray technology, dispenser technology, and inkjet method.

30. The method for producing an electrostatic film sound transducer (1) according to claim 29, wherein the substrate (2) is produced by a printing technology selected from one or more of intaglio printing, screen printing, gravure technology, spray technology, dispenser technology, and inkjet method.

31. A system, comprising at least two electrostatic film sound transducers (1) according to claim 1.

32. The system according to claim 33, wherein the at least two electrostatic film sound transducers (1) are arranged so that sound radiation (11) therefrom is effected substantially parallelwise.

33. The system according to claim 33, wherein the at least two electrostatic film sound transducers (1) are arranged so that the sound radiation (11) therefrom is effected substantially in a non-parallel manner.
